(19) United States
(12) Patent Application Publication
(10) Pub. No.: US 2021/0249962 A1
(43) Pub. Date: Aug. 12, 2021

(54) CONVERTER

(71) Applicant: DIAMOND ELECTRIC MFG. CO., LTD., Osaka (JP)

(72) Inventors: Masao WATANABE, Osaka (JP); Shogo NAKAHARA, Osaka (JP)

(21) Appl. No.: 16/973,726

(22) PCT Filed: Jul. 23, 2019
(86) PCT No.: PCT/JP2019/028827

§ 371 Date: Dec. 9, 2020

(30) Foreign Application Priority Data
Aug. 27, 2018 (JP) 2018-158639

(51) Int. Cl. H02M 3/335; H02M 1/00

(52) U.S. Cl. CPC H02M 3/33576; H02M 1/0058

(57) ABSTRACT

A DC-DC converter has a configuration in which a first full-bridge circuit and a second full-bridge circuit are connected via a transformer and an inductor. The first full-bridge circuit is on a low-voltage side, and the second full-bridge circuit is on a high-voltage side. A control circuit soft-switches each switching element in the second full-bridge circuit, hard-switches at least one of the switching elements in the first full-bridge circuit, and soft-switches the other switching elements in the first full-bridge circuit. Accordingly, the DC-DC converter can achieve soft-switching while suppressing a decrease in power transfer efficiency.

### TECHNICAL FIELD

The present invention relates to a converter that implements soft-switching.

### BACKGROUND ART

Electric power conversion systems such as DC-DC converters have widely adopted zero voltage switching in recent years as one method of switching control of power transistors. The zero voltage switching is hereinafter referred to as “ZVS.” The switching control enables reducing switching losses and achieving high-efficiency power transfer and also enables reducing noise and suppressing switching surges so as to allow the use of low voltage-proof and low-cost devices. Patent Literature 1 introduces a technique for implementing ZVS operations when a large voltage difference exists between a primary-side DC voltage and a secondary-side DC voltage. This DC-DC converter detects power on each of the primary and secondary sides and increases or decreases the duties of primary-side switches and secondary-side switches in order to minimize a power difference between the primary and secondary sides. In this way, the systems apply a design philosophy of always implementing ZVS operations.

### PRIOR ART DOCUMENT

### Patent Literature

Patent Literature 1: Japanese Patent Application Laid-Open No. 2016-012970

### SUMMARY OF INVENTION

### Problem to be Solved by Invention

As can be seen from the above-described efforts, it is a very difficult demand to implement ZVS operations in both full-bridge circuits, and it may be inherently impossible to always satisfy this. In view of this, the inventors of the present invention have found a revolutionary new switching operation that limitedly allows operation control that deviates from ZVS while suppressing a decrease in power transfer efficiency.

It is an object of the present invention to provide a converter that implements soft-switching while suppressing a decrease in power transfer efficiency.

### Means for Solving Problems

A converter according to a first aspect of the present application includes a first full-bridge circuit including a first leg in which two switching elements are connected in series, and a second leg in which two switching elements are connected in series, a second full-bridge circuit including a third leg in which two switching elements are connected in series, and a fourth leg in which two switching elements are connected in series, a transformer including a first winding and a second winding that are magnetically coupled to each other, the first winding having one end connected to a midpoint of the first leg and having the other end connected to a midpoint of the second leg, and the second winding having one end connected to a midpoint of the third leg and having the other end connected to a midpoint of the fourth leg, and a control circuit that controls switching of each switching element in each of the first full-bridge circuit and the second full-bridge circuit. The first full-bridge circuit is on a low-voltage side, and the second full-bridge circuit is on a high-voltage side. The control circuit soft-switches each switching element in the second full-bridge circuit. The control circuit hard-switches at least one of the switching elements in the first full-bridge circuit and soft-switches the other switching elements.

A converter according to a second aspect of the present application is the converter according to the first aspect, in which the control circuit hard-switches the two switching elements in one of the first leg and the second leg, and soft-switches the two switching elements in the other of the first leg and the second leg.

A converter according to a third aspect of the present application is the converter according to the first or second aspect, in which the control circuit controls active power and reactive power that are output from one of the first full-bridge circuit and the second full-bridge circuit to the other of the first full-bridge circuit and the second full-bridge circuit, and hard-switches a switching element in the other of the first full-bridge circuit and the second full-bridge circuit when the reactive power is switched to the active power.

A converter according to a fourth aspect of the present application is the converter according to any one of the first to third aspects. The converter further includes an inductance component connected in series to the first winding or the second winding, in each switching element in each of the first full-bridge circuit and the second full-bridge circuit includes a capacitor serving as a parasitic capacitance or an external capacitor connected in parallel to the switching element, an inductor current that flows through an equivalent inductor of the transformer and the inductance component with timing of switching between turn-on and turn-off of the switching elements that are to be soft-switched is larger than or equal to a threshold current, and the threshold current is set to make energy accumulated in the equivalent inductor greater than or equal to energy accumulated in the capacitors of the switching elements that are to be soft-switched.

A converter according to a fifth aspect of the present application is the converter according to the fourth aspect, in which I_{ref}=α·V_{X}√(2C/L) is satisfied, where I_{ref} is the threshold current, Vₓ is an input voltage of the first full-bridge circuit, C is a capacitance of the capacitor, L is an inductance of the equivalent inductor, and α is a correction factor.

A converter according to a sixth aspect of the present application is the converter according to the fourth aspect, in which I_{ref}=α·Vₓ√(4C/L) is satisfied, where I_{ref} is the threshold current, Vₓ is an input voltage of the first full-bridge circuit, C is a capacitance of the capacitor, L is an inductance of the equivalent inductor, and a is a correction factor.

### Effects of Invention

According to the first to sixth aspects of the present application, in the first full-bridge circuit on the low-voltage side, the control circuit hard-switches at least one switching element, instead of soft-switching the switching element(s). Accordingly, even if switching timing overlaps between the first full-bridge circuit and the second full-bridge circuit, the second full-bridge circuit on the high-voltage side, which strongly influences power transfer efficiency, can satisfy soft-switching conditions and can soft-switch the switching elements.

### BRIEF DESCRIPTION OF DRAWINGS

FIG. 1 is a circuit diagram of a DC-DC converter according to an embodiment.

FIG. 2 is a timing chart of turn-on and turn-off of each switching element.

FIG. 3 is a diagram for describing a current path in the DC-DC converter.

FIG. 4 is a diagram for describing a current path in the DC-DC converter.

FIG. 5 is a diagram for describing a current path in the DC-DC converter.

### DESCRIPTION OF EMBODIMENT

Hereinafter, an embodiment of the present invention will be described with reference to the drawings. A “converter” according to the present invention will be described hereinafter, using a DC-DC converter as an example. As one example of soft-switching, ZVS is described.

1. Circuit Configuration of DC-DC Converter

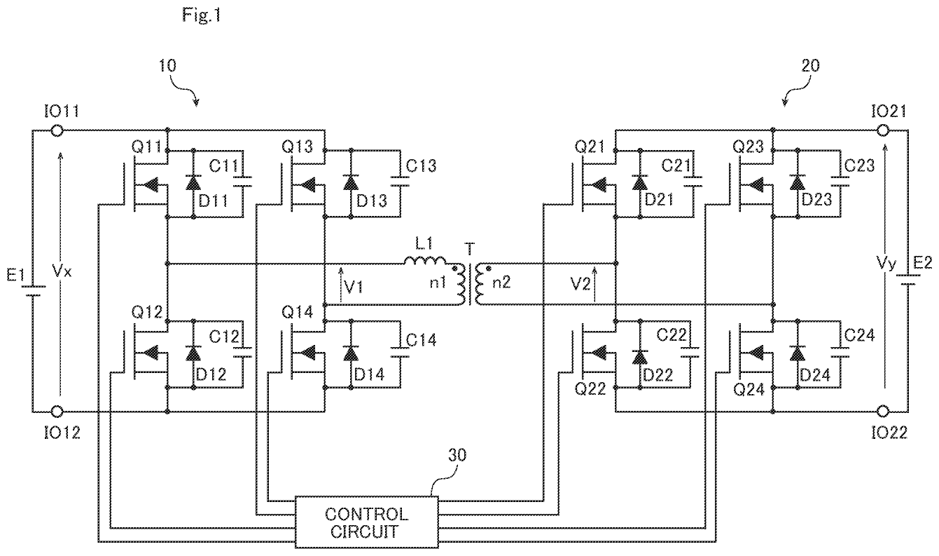

FIG. 1 is a circuit diagram of a DC-DC converter 1 according to the embodiment.

The DC-DC converter 1 includes a pair of input/output terminals IO11 and IO12 and a pair of input/output terminals IO21 and IO22. The input/output terminals IO11 and IO12 are connected to a direct-current (DC) power supply E1. The input/output terminals IO21 and IO22 are connected to a DC power supply E2. The DC-DC converter 1 transforms a power supply voltage of the DC power supply E1 that is input from the input/output terminals IO11 and IO12 and outputs a resultant voltage from the input/output terminals IO21 and IO22. The DC-DC converter 1 also transforms a power supply voltage of the DC power supply E2 that is input from the input/output terminals IO21 and IO22 and outputs a resultant voltage from the input/output terminals IO11 and IO12. That is, the DC-DC converter 1 is a converter capable of bidirectional power transfer.

The DC-DC converter 1 includes a first full-bridge circuit 10, a second full-bridge circuit 20, and a transformer T.

The transformer T includes a first winding n1 and a second winding n2. The first winding n1 and the second winding n2 are magnetically coupled to each other. The first winding n1 is connected to the input/output terminals IO11 and IO12 via the first full-bridge circuit 10. The second winding n2 is connected to the input/output terminals IO21 and IO22 via the second full-bridge circuit 20.

The first full-bridge circuit 10 includes a first leg in which switching elements Q11 and Q12 are connected in series, and a second leg in which switching elements Q13 and Q14 are connected in series.

One end of the first winding n1 of the transformer T is connected to a midpoint of the first leg. The other end of the first winding n1 of the transformer T is connected to a midpoint of the second leg. An inductor L1 is provided between the first winding n1 of the transformer T and the midpoint of the first leg. However, it is sufficient for the inductor L1 to be connected in series to either the first winding n1 or the second winding n2, and the location of the inductor L1 may be appropriately changed. For example, the inductor L1 may be provided between the first winding n1 and the midpoint of the second leg. The inductor L1 may be a real element, or a leakage inductance of the transformer T, or a combination of a real element and a leakage inductance.

The switching elements Q11, Q12, Q13, and Q14 are respectively connected in parallel to the diodes D11, D12, D13, and D14 and respectively connected in parallel to the capacitors C11, C12, C13, and C14. The switching elements Q11 to Q14 are MOSFETs. Alternatively, the switching elements Q11 to Q14 may be other transistors such as IGBTs or JFETs. The diodes D11 to D14 may be external real elements, or may be parasitic diodes. The capacitors C11 to C14 each may be an external real element, or a parasitic capacitance, or a combination of a parasitic capacitance and a real element.

The second full-bridge circuit 20 includes a third leg in which switching elements Q21 and Q22 are connected in series, and a fourth leg in which switching elements Q23 and Q24 are connected in series.

One end of the second winding n2 of the transformer T is connected to a midpoint of the third leg. The other end of the second winding n2 of the transformer T is connected to a midpoint of the fourth leg. The aforementioned inductor L1 may be provided between the second winding n2 and the midpoint of the third leg, or may be provided between the second winding n2 and the midpoint of the fourth leg.

The switching elements Q21, Q22, Q23, and Q24 are respectively connected in parallel to the diodes D21, D22, D23, and D24 and respectively connected in parallel to the capacitors C21, C22, C23, and C24. The switching elements Q21 to Q24 are MOSFETs. Alternatively, the switching elements Q21 to Q24 may be other transistors such as IGBTs or JFETs. The diodes D21 to D24 may be external real elements, or may be parasitic diodes. The capacitors C21 to C24 each may be an external real element, or a parasitic capacitance, or a combination of a parasitic capacitance and a real element.

Each of the switching elements Q11 to Q14 and Q21 to Q24 has a gate terminal connected to the control circuit 30. The control circuit 30 performs switching control of each of the switching elements Q11 to Q14 and Q21 to Q24 so that the output power of the DC-DC converter 1 becomes set target power. In the present embodiment, the control circuit 30 soft-switches any of the switching elements Q11 to Q14 and Q21 to Q24 in order to reduce switching losses.

2 . Soft-Switching Operation

Switching operations of the switching elements Q11 to Q14 and Q21 to Q24 will be described hereinafter. The present embodiment adopts 3-level dual active bridge (DAB) control.

The DC-DC converter 1 transfers power from either the input/output terminals IO11 and IO12 or the input/output terminals IO21 and IO22 to the other, or vice versa. The following description is given on the assumption that the input/output terminals IO11 and IO12 are on the input side and the input/output terminals IO21 and IO22 are on the output side. In the present embodiment, the first full-bridge circuit 10 is assumed to be on the low voltage side, and the second full-bridge circuit 20 is assumed to be on the high voltage side.

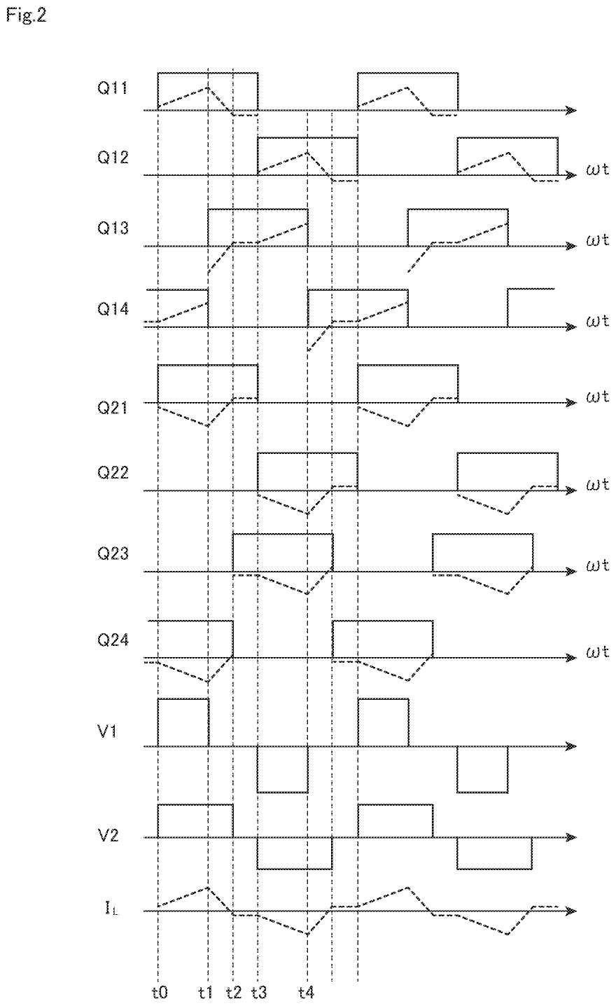

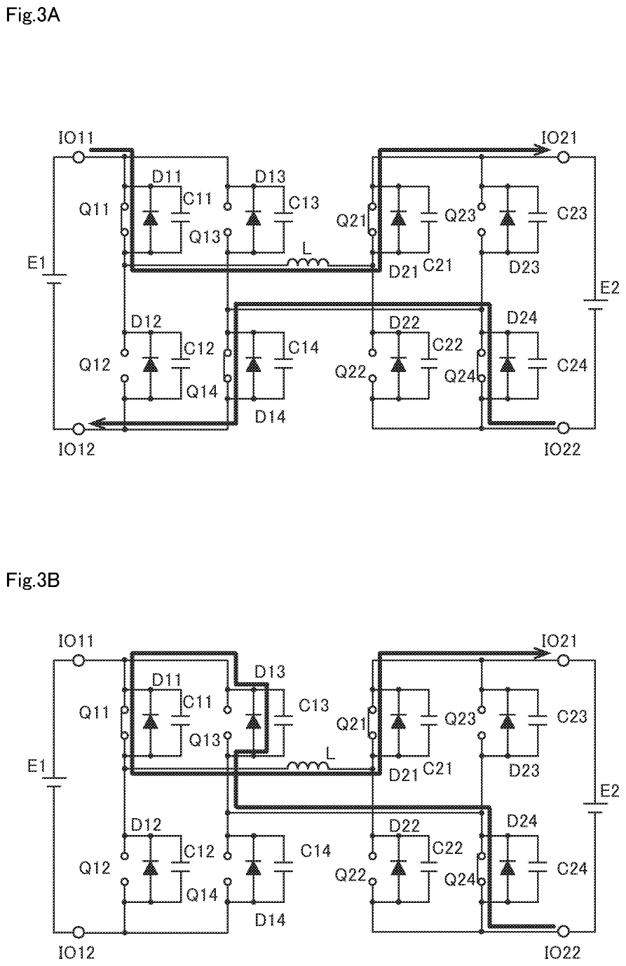

FIG. 2 is a timing chart of turn-on and turn-off of the switching elements Q11 to Q14 and Q21 to Q24. FIGS. 3, 4, and 5 are diagrams for describing current paths in the DC-DC converter 1. In FIGS. 3 to 5, the inductor L1 and the transformer T in FIG. 1 are expressed as an equivalent inductor L. This inductor L is one example of an inductance component according to the present invention. In each drawing, the switching elements are indicated by a simplified circuit symbol.

In FIG. 2, V1 indicates the potential difference between the midpoint of the switching elements Q11 and Q12 and the midpoint of the switching elements Q13 and Q14, illustrated in FIG. 1. V2 indicates the potential difference between the midpoint of the switching elements Q21 and Q22 and the midpoint of the switching elements Q23 and Q24. I_{L} indicates the current flowing through the inductor L. Referring to the switching elements Q11 to Q14 and Q21 to Q24 in FIG. 2, the solid-line waveform indicates the waveform of the gate-source voltage, and the broken-line waveform indicates the waveform of the drain current.

Period from t0 to t1

In the period from t0 to t1, the switching elements Q11 and Q14 and the switching elements Q21 and Q24 are all in the ON state. Also, the switching elements Q12 and Q13 and the switching elements Q22 and Q23 are all in the OFF state during the period from t0 to t1. In this case, current flows in sequence from the DC power supply E1 through the switching element Q11, the inductor L, the switching element Q21, the DC power supply E2, and the switching element Q24 to the switching element Q14 as illustrated in FIG. 3(A). The power supply voltages of the DC power supplies E1 and E2 are applied to the inductor L. That is, the inductor current I_{L} increases as illustrated in FIG. 2.

With timing t1, the switching element Q14 is turned off, and the switching element Q13 is turned on. At this time, a dead time is provided between the turn-off of the switching element Q14 and the turn-on of the switching element Q13. During this dead time, the switching elements Q13 and Q14 are both in the OFF state. Due to the property of the inductor L, the inductor current I_{L} continues to flow through the inductor L.

Thus, current flows from the second full-bridge circuit 20 to each of the capacitors C13 and C14 of the first full-bridge circuit 10 during the dead time. Then, the capacitor C13 is discharged, and the capacitor C14 is charged. When the discharge of the capacitor C13 has been completed, the diode D13 is turned on as illustrated in FIG. 3(B). That is, the drain-source voltage of the switching element Q13 is zero. At this time, ZVS is achieved at turn-on of the switching element Q13.

Period from t1 to t2

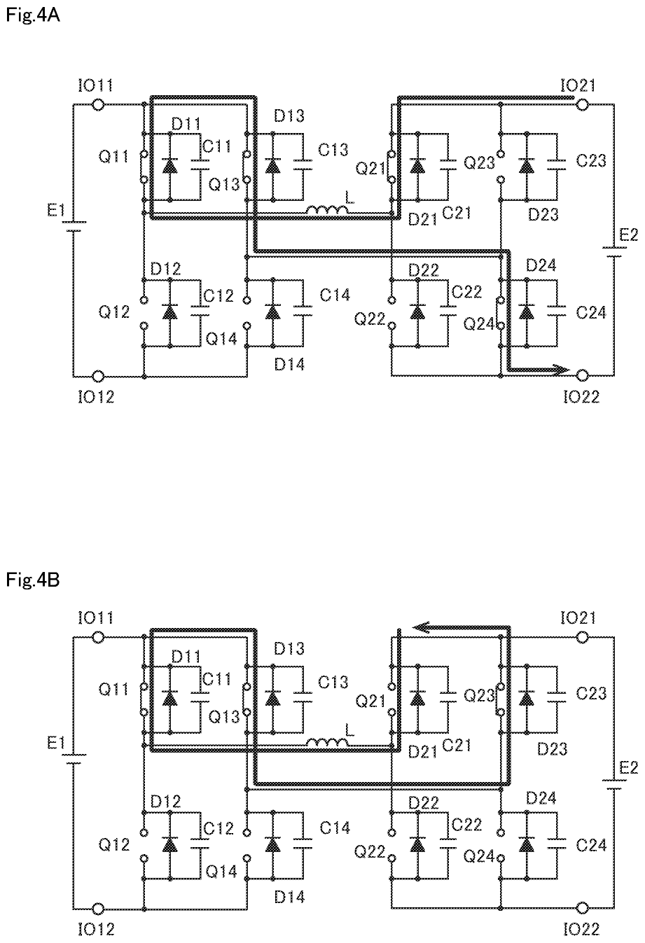

During the period from t1 to t2, the switching elements Q11 and Q13 and the switching elements Q21 and Q24 are all in the ON state. Also, the switching elements Q12 and Q14 and the switching elements Q22 and Q23 are all in the OFF state during the period from t1 to t2. In this case, current flows in sequence from the DC power supply E2 through the switching element Q21, the inductor L, the switching element Q11, and the switching element Q13 to the switching element Q24 as illustrated in FIG. 4(A). That is, the inductor current I_{L} flows in the opposite direction to the direction of flow during the period from t0 to t1. Thus, the inductor current I_{L} decreases as illustrated in FIG. 2.

With timing t2, the switching element Q24 is turned off, and the switching element Q23 is turned on. At this time, a dead time is provided between the turn-off of the switching element Q24 and the turn-on of the switching element Q23. During this dead time, current flows from the first full-bridge circuit 10 to each of the capacitors C23 and C24 of the second full-bridge circuit 20, as described for the timing t1. Then, the capacitor C23 is discharged, and the capacitor C24 is charged. When the discharge of the capacitor C23 has been completed, the diode D23 is turned on. That is, the drain-source voltage of the switching element Q23 is zero. At this time, ZVS is achieved at turn-on of the switching element Q23. Then, current flows through the path illustrated in FIG. 4(B).

Period from t2 to t3

During the period from t2 to t3, the switching elements Q11 and Q13 and the switching elements Q21 and Q23 are all in the ON state. Also, the switching elements Q12 and Q14 and the switching elements Q22 and Q24 are all in the OFF state during the period from t2 to t3. In this case, current flows through the path illustrated in FIG. 4(B). The power supply voltages of the DC power supplies E1 and E2 are not applied to the inductor L, and the inductor current I_{L} remains unchanged as illustrated in FIG. 2. That is, the inductor current I_{L} during this period is reactive current, and power during this period is reactive power.

With timing t3, in the first full-bridge circuit 10, the switching element Q11 is turned off, and the switching element Q12 is turned on. In the second full-bridge circuit 20, the switching element Q21 is turned off, and the switching element Q22 is turned on. In this case, each of the first full-bridge circuit 10 and the second full-bridge circuit 20 needs to satisfy conditions described later in order to achieve ZVS. However, with the control according to the present embodiment, it is difficult for each of the first full-bridge circuit 10 and the second full-bridge circuit 20 to satisfy the later-described conditions. The reasons for this will be described below.

In the first full-bridge circuit 10 on the low-voltage side according to the present embodiment, the switching element Q12 is turned on with timing between the turn-off of the switching element Q11 and the turn-on of the switching element Q12. That is, the switching element Q12 fails to satisfy ZVS conditions and is thus hard-switched.

On the other hand, in the second full-bridge circuit 20 on the high-voltage side, dead timing is provided between the turn-off of the switching element Q21 and the turn-on of the switching element Q22. With this dead timing, the capacitor C22 is discharged, and the diode D22 is turned on. At this time, ZVS is achieved at turn-on of the switching element Q22.

Period from t3 to t4

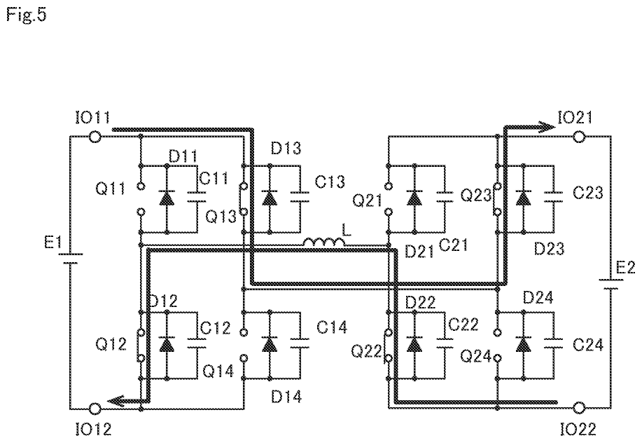

During the period from t3 to t4, the switching elements Q12 and Q13 and the switching elements Q22 and Q23 are all in the ON state. Also, the switching elements Q11 and Q14 and the switching elements Q21 and Q24 are all in the OFF state during the period from t3 to t4. In this case, current flows through the path illustrated in FIG. 5. The power supply voltages of the DC power supplies E1 and E2 are applied to the inductor L in the opposite direction to the direction in the case of FIG. 3(A), and the inductor current I_{L} decreases as illustrated in FIG. 2.

With timing t4, the capacitor C14 is discharged, and the diode D14 is turned on during a dead time as described for the timing t1. At this time, ZVS is achieved at turn-on of the switching element Q14.

3. ZVS Conditions

Hereinafter, the conditions for implementing ZVS will be described in detail.

The following description is given of an example using the timing t1. As described above, if the drain-source voltage of the switching element Q13 that is to be switched is zero after the capacitors C13 and C14 have been charged or discharged by the inductor L during the dead time with the timing t1, ZVS is achieved at turn-on of the switching element Q13. That is, ZVS of the switching element Q13 can be achieved if the energy of the inductor L is at least greater than or equal to the total energy accumulated in each of the capacitors C13 and C14.

Here, the above conditions are satisfied if Expression (1) below holds true.

[Expression 1]

½LI_{L}²≥½·2CVₓ² (1)

where L is the inductance of the inductor L, C is the capacitance of each of the capacitors C11 to C14 and C21 to C24, and Vₓ (see FIG. 1) is the power supply voltage of the DC power supply E1.

Expression (1) is transformed into Expression (2) below. Note that a in Expression (2) is a correction factor and set to an appropriate value as necessary. In the following example, it is assumed that α=1.

$$\begin{matrix}[ Expression 2 ] & \\ {I}_{L} ≧ α \cdot {V}_{X} \sqrt{\frac{2 C}{L}} & ( 2 )\end{matrix}$$

In Expression (2), α·Vₓ·(2CL/L) is the threshold current I_{ref}. If |I_{L}|≥|I_{ref}| is satisfied during the dead time with the timing t1, ZVS of the switching element Q13 becomes possible. Even with other timing, ZVS becomes possible if |I_{K}|≥|I_{ref}| is satisfied.

However, with the timing t3, the switching elements are turned on or off in each of the first full-bridge circuit 10 and the second full-bridge circuit 20 as described above. With the timing t3, current flows through the path illustrated in FIG. 4(B). In the first full-bridge circuit 10, the switching element Q11 and the inductor L are of the same polarity. In the second full-bridge circuit 20, the switching element Q21 and the inductor L are of opposite polarities. That is, the condition for implementing ZVS of the switching element Q11 is I_{L}>0, and the condition for implementing ZVS of the switching element Q21 is I_{L}<0. Accordingly, it is impossible to satisfy both of the conditions for implementing ZVS of the switching elements Q11 and Q21.

In view of this, in the present embodiment, when reactive power is switched to active power, the switching element Q11 in the first full-bridge circuit 10 on the low-voltage side, which less influences power transfer efficiency, is hard-switched, instead of being switched at zero volts (ZVS). This allows the second full-bridge circuit 20 on the high-voltage side, which strongly influences power transfer efficiency, to satisfy ZVS conditions and implement ZVS of the switching element Q21.

The same applies to the case where the switching element Q11 is turned on and the switching element Q21 is turned off with the timing t0. That is, with the timing t0, the switching element Q11 is hard-switched, and the switching element Q21 is switched at zero volts (ZVS). In this way, in the present embodiment, only the bridge circuit 10 on the low-voltage side uses hard-switching.

As described above, in the present embodiment, switching timing overlaps between the first leg and the third leg. Thus, the switching elements Q11 and Q12 in the first leg of the first full-bridge circuit 10 on the low-voltage side are hard-switched. This allows the second full-bridge circuit 20 on the high-voltage side to implement ZVS of the switching elements Q21 and Q22. Implementing ZVS of each switching element in the second, third, and fourth legs reduces switching losses and suppresses a decrease in power transfer efficiency.

That is, it is to be understood that this is an instance in which at least either of the two bridge circuits has to use hard-switching. In this instance, it is found that the bridge circuit 10 on the low-voltage side temporarily allows hard-switching, whereas the bridge circuit 20 on the high-voltage side always continues ZVS operations. In this way, according to the present embodiment, a power transistor suitable for the electrical conditions of the bridge circuit 20 on the high-voltage side can be selected in the design of the bridge circuit 20 on the high-voltage side. On the other hand, the bridge circuit 10 on the low-voltage side, which is characteristically controlled at low voltages, does not increase switching surges and therefore can use power transistors having low-cost voltage-proof specifications. As described above, the converter according to the present embodiment makes some contrivances in order to avoid an increase in the specification of power transistors to be mounted, in the circuit as a whole.

4. Variations

Although one embodiment of the present invention has been described thus far, the present invention is not intended to be limited to the above-described embodiment.

The above embodiment has been described on the assumption that the input/output terminals IO11 and 1012 are on the input side and the input/output terminals IO21 and IO22 are on the output side. However, the DC-DC converter 1 is capable of bidirectional power transfer. Accordingly, the input/output terminals IO11 and 1012 may be on the output side, and the input/output terminals IO21 and IO22 may be on input side. This case can be described in the same manner as the above-described embodiment, and therefore a description thereof shall be omitted. Note that the DC-DC converter 1 does not necessarily have to be a bidirectional converter.

The conditions for satisfying ZVS may be appropriately changed depending on the switching timing of each switching element. For example, in the case where the switching elements Q11 to Q14 in the first full-bridge circuit 10 are turned off with dead timing, ZVS of the switching elements Q11 to Q14 can be achieved if the energy of the inductor L is at least greater than or equal to the total energy accumulated in each of the capacitors C11 to C14. In this case, ZVS of the switching elements Q11 to Q14 can be achieved by appropriately making settings such that the inductor current I_{L} larger than or equal to the threshold current I_{ref} (I_{ref}=α·Vₓ√(4C/L)) flows through the inductor L.

Each element in the embodiment and variations described above may be combined appropriately within a range that presents no contradictions.

### REFERENCE SIGNS LIST

1: DC-DC converter

10: First full-bridge circuit

20: Second full-bridge circuit

30: Control circuit

C11, C12, C13, C14: Capacitor

C21, C22, C23, C24: Capacitor

D11, D12, D13, D14: Diode

D21, D22, D23, D24: Diode

E1: DC power supply

E2: DC power supply

IO1: Input/output terminal

IO12: Input/output terminal

IO21: Input/output terminal

IO22: Input/output terminal

L: Inductor

L1: Inductor

Q11, Q12, Q13, Q14: Switching element

Q21, Q22, Q23, Q24: Switching element

T: Transformer

Vₓ: Power supply voltage

V_{y}: Power supply voltage

V1: Voltage

V2: Voltage

n1: First winding

n2: Second winding

1. A converter comprising:
a first full-bridge circuit including a first leg in which two switching elements are connected in series, and a second leg in which two switching elements are connected in series;
a second full-bridge circuit including a third leg in which two switching elements are connected in series, and a fourth leg in which two switching elements are connected in series;
a transformer including a first winding and a second winding that are magnetically coupled to each other, the first winding having one end connected to a midpoint of the first leg and having the other end connected to a midpoint of the second leg, and the second winding having one end connected to a midpoint of the third leg and having the other end connected to a midpoint of the fourth leg; and
a control circuit that controls switching of each switching element in each of the first full-bridge circuit and the second full-bridge circuit,
wherein the first full-bridge circuit is on a low-voltage side, and the second full-bridge circuit is on a high-voltage side,
the control circuit soft-switches each switching element in the second full-bridge circuit, and
the control circuit hard-switches at least one of the switching elements in the first full-bridge circuit and soft-switches the other switching elements.

2. The converter according to claim 1, wherein
the control circuit hard-switches the two switching elements in one of the first leg and the second leg, and soft-switches the two switching elements in the other of the first leg and the second leg.

3. The converter according to claim 1, wherein
the control circuit controls active power and reactive power that are output from one of the first full-bridge circuit and the second full-bridge circuit to the other of the first full-bridge circuit and the second full-bridge circuit, and hard-switches a switching element in the other of the first full-bridge circuit and the second full-bridge circuit when the reactive power is switched to the active power.

4. The converter according to claim 1, further comprising:
an inductance component connected in series to the first winding or the second winding,
wherein each switching element in each of the first full-bridge circuit and the second full-bridge circuit includes a capacitor serving as a parasitic capacitance or an external capacitor connected in parallel to the switching element,
an inductor current that flows through an equivalent inductor of the transformer and the inductance component with timing of switching between turn-on and turn-off of the switching elements that are to be soft-switched is larger than or equal to a threshold current, and
the threshold current is set to make energy accumulated in the equivalent inductor greater than or equal to energy accumulated in the capacitors of the switching elements that are to be soft-switched.

5. The converter according to claim 4, wherein
I_{ref}=α·Vₓ√(2C/L) is satisfied,
where I_{ref} is the threshold current, Vₓ is an input voltage of the first full-bridge circuit, C is a capacitance of the capacitor, L is an inductance of the equivalent inductor, and α is a correction factor.

6. The converter according to claim 4, wherein
I_{ref}=α·Vₓ√(4V/L) is satisfied,
where I_{ref} is the threshold current, Vₓ is an input voltage of the first full-bridge circuit, C is a capacitance of the capacitor, L is an inductance of the equivalent inductor, and α is a correction factor.

7. The converter according to claim 2, wherein
the control circuit controls active power and reactive power that are output from one of the first full-bridge circuit and the second full-bridge circuit to the other of the first full-bridge circuit and the second full-bridge circuit, and hard-switches a switching element in the other of the first full-bridge circuit and the second full-bridge circuit when the reactive power is switched to the active power.
